(19) United States
(12) Patent Application Publication
(10) Pub. No.: US 2013/0117355 A1
(43) Pub. Date: May 9, 2013

(54) APPARATUS AND METHOD FOR TRANSMITTING DATA IN A MOBILE COMMUNICATION SYSTEM

(71) Applicant: Samsung Electronics Co., Ltd., Gyeonggi-do (KR)

(72) Inventor: Keun-Hee KIM, Gyeongsangbuk-do (KR)

(73) Assignee: SAMSUNG ELECTRONICS CO., LTD., Gyeonggi-do (KR)

(21) Appl. No.: 13/668,406

(22) Filed: Nov. 5, 2012

(30) Foreign Application Priority Data
Nov. 4, 2011 (KR) 10-2011-0114632

(51) Int. Cl. G06F 15/16

(52) U.S. Cl. 709/203

(57) ABSTRACT

An apparatus and method transmit data using a relay server in a mobile communication system. The apparatus includes a server controller, a connection check unit, and a communication unit. The server controller receives data, requested by a portable terminal, from a data server. The connection check unit checks a heterogeneous network handover of the portable terminal. The communication unit communicates with the portable terminal and the data server. The server controller processes to transmit data received from the data server, through a first communication connection and, when the portable terminal intends to perform the heterogeneous network handover to buffer data received from the data server, and then, at a time point at which the portable terminal completes heterogeneous network handover execution, to transmit the buffered data through a second communication connection.

### CLAIM OF PRIORITY

This application claims, pursuant to 35 U.S.C. §119(a), priority to and the benefit of the earlier filing date of a Korean Patent Application filed in the Korean Intellectual Property Office on Nov. 4, 2011 and assigned Serial No. 10-2011-0114632, the contents of which are herein incorporated by reference.

### BACKGROUND OF THE INVENTION

1. Field of the Invention

The present invention relates to a data reception apparatus and method of a portable terminal. More particularly, the present invention relates to an apparatus and method for a portable terminal to receive data through a heterogeneous network in a mobile communication network.

2. Description of the Related Art

In recent years, portable terminals, a necessity to modern people, have become widely used. Service providers and system manufacturers are competitively developing services and products for the differentiation of their businesses from other enterprises using portable terminals.

For example, portable terminals have evolved into multimedia equipment for accessing phone books, games, short messages, electronic mail (e-mail) messages, morning wakeup calls, MPEG-1 Audio Layer 3 (MP3) players, schedule management functions, digital cameras, and wireless Internet services and for providing a variety of services.

Wireless Internet service has become widely used due to its convenience such that users of portable terminals can easily use the Internet without regard to their location.

As known in the art, wireless Internet service can be used through a mobile communication network or a WiFi network.

In case of using the mobile communication network, a user can confirm his/her desired information at all times and in all places by means of payment of a data charge for wireless Internet use. In the case of using a WiFi network, the user can use the Internet free of charge through access to an Access Point (AP).

When a user searches an AP for access to a WiFi network in the course of using wireless Internet through a mobile communication network, he/she intends to access, through the AP, an available WiFi network having better performance compared to the mobile communication network.

In the case where the portable terminal searches the WiFi network in the course of receiving data through the mobile communication network, the portable terminal will access the WiFi network so as to improve a transmission speed and reduce a cost of the use of a wireless Internet.

However, although the portable terminal has access to the WiFi network from the mobile communication network, a data server for transmitting data to the portable terminal fails to recognize the fact that the portable terminal may have performed a handover to the WiFi network from the mobile communication network. Accordingly, there is a problem that the data server keeps transmitting data to the portable terminal through the mobile communication network despite the fact the portable terminal performs a handover to the WiFi network.

Because of this, there occurs a problem that the amount of data use through the mobile communication network increases and even a cost of the use of wireless Internet increases, despite the fact that the user of the portable terminal performs a handover to the WiFi network.

Accordingly, to provide a solution to the above problem, a data provision apparatus and method of a mobile communication system are needed.

### SUMMARY OF THE INVENTION

An aspect of the present invention is to substantially solve at least the above problems and/or disadvantages and to provide at least the advantages below. Accordingly, one aspect of the present invention is to provide an apparatus and method for improving data reception performance in a mobile communication system.

Another aspect of the present invention is to provide an apparatus and method for performing handover during data reception in a portable terminal.

A further aspect of the present invention is to provide an apparatus and method for improving a data reception speed through heterogeneous network handover in a portable terminal.

The above aspects are achieved by providing an apparatus and method for transmitting data in a mobile communication system.

According to one aspect of the present invention, an apparatus for transmitting data in a relay server is provided. The apparatus includes a server controller, a connection check unit, and a communication unit. The server controller receives data, requested by a portable terminal, from a data server. The connection check unit checks a heterogeneous network handover of the portable terminal. The communication unit communicates with the portable terminal and the data server. The server controller processes to transmit data, received from the data server, to the portable terminal through a first communication connection and, when it is checked that the portable terminal intends to perform the heterogeneous network handover, to buffer data received from the data server and then, at a time point at which the portable terminal completes heterogeneous network handover execution, to transmit the buffered data to the portable terminal through a second communication connection.

According to another aspect of the present invention, a method for transmitting data in a relay server is provided. The method includes receiving data requested by a portable terminal, from a data server, transmitting the data, received from the data server, to the portable terminal through a first communication connection and, when it is checked that the portable terminal intends to perform heterogeneous network handover, buffering data received from the data server and, when the portable terminal completes heterogeneous network handover execution, transmitting the buffered data to the portable terminal through a second communication connection. The heterogeneous network handover establishes a communication connection to a second communication network in a state of connection with a first communication network.

According to another aspect of the present invention, a method for receiving a data in a portable terminal is provided. The method includes sending a data request to a relay server; receiving requested data using a first communication connection from the relay server and receiving requested data using a second communication connection from the relay server when the portable terminal performs a heterogeneous network handover.

According to a further aspect of the present invention, a mobile communication system for data transmission is provided. The system includes a portable terminal, a relay server, and a data server. The portable terminal sends a data request to the data server via the relay server, and receives requested data from the data server. The relay server transmits a data request of the portable terminal to the data server, and transmits data, received from the data server, to the portable terminal. The data server stores a plurality of data, searches data corresponding to a data request of the portable terminal, and provides the searched data to the relay server. The relay server transmits data, provided from the data server, to the portable terminal through a first communication connection and, when the portable terminal performs heterogeneous network handover, transmits data, provided from the data server, to the portable terminal through a second communication connection.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a construction of a mobile communication system according to an exemplary embodiment of the present invention;

FIG. 2 is a flowchart illustrating a process of receiving data in a portable terminal according to the exemplary embodiment of the present invention;

FIG. 3 is a flowchart illustrating a process of providing data in a relay server according to the exemplary embodiment of the present invention;

FIG. 4 is a ladder diagram illustrating a data transmission process of a mobile communication system according to the exemplary embodiment of the present invention; and

FIG. 5 is a ladder diagram illustrating a data transmission process of a mobile communication system according to an alternative exemplary embodiment of the present invention.

### DETAILED DESCRIPTION OF THE INVENTION

Preferred embodiments of the present invention will be described herein below with reference to the accompanying drawings. In the following description, well-known functions or constructions are not described in detail since they may obscure the invention with unnecessary detail.

This invention may, however, be embodied in many different forms and should not be construed as limited to the exemplary embodiments set forth herein. The same reference numbers are used throughout the drawings to refer to the same or like parts. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

The present invention relates to an apparatus and method for a portable terminal to receive data through a heterogeneous network at the time of performing a handover to the heterogeneous network in the course of receiving data using a mobile communication network.

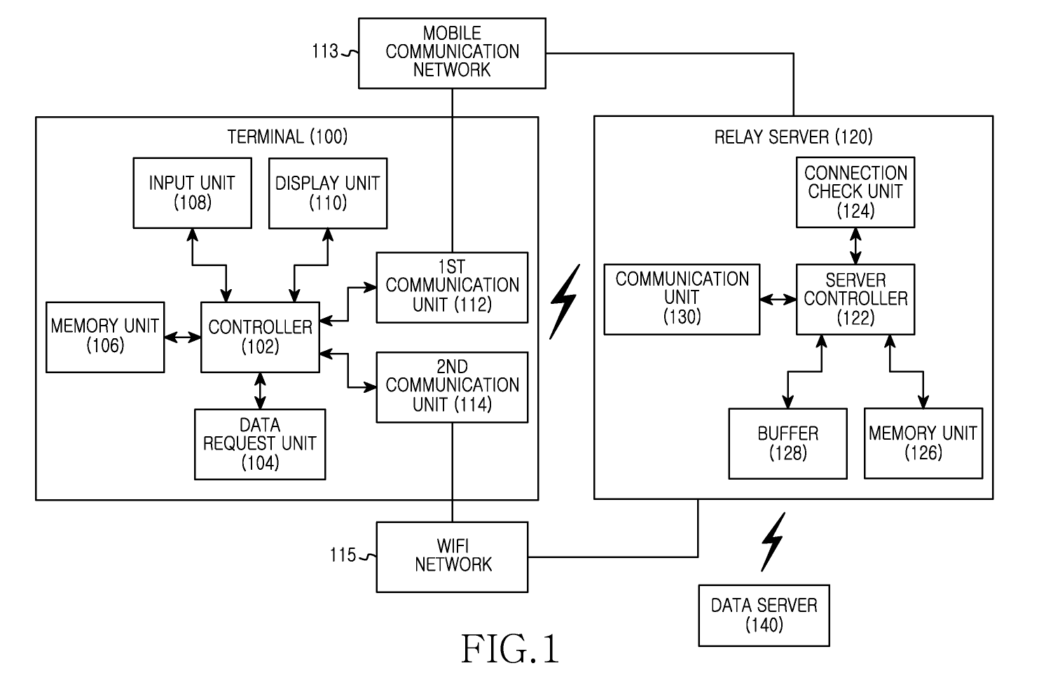

FIG. 1 is a block diagram illustrating a construction of a mobile communication system according to an exemplary embodiment of the present invention.

Referring to FIG. 1, the mobile communication system includes a portable terminal 100, a relay server 120, and a data server 140.

First, the portable terminal 100 includes a controller 102, a data request unit 104, a memory unit 106, an input unit 108, a display unit 110, a first communication unit 112, and a second communication unit 114.

The controller 102 controls the general operation of the portable terminal 100. For example, the controller 102 performs processing and control for voice calls and data communication. In addition to general functions, according to the present invention, the controller 102 processes to change a communication mode according to signals received from a plurality of systems, to maintain communication connection, and to receive data from each system.

That is, at data reception, after processing to perform handover to a heterogeneous system, the controller 102 processes to receive data through the handover heterogeneous system. For example, when the controller 102 confirms a connection with a system corresponding to the second communication unit 114 in the course of receiving data through the first communication unit 112, the controller 102 processes to discontinue receiving the data through the first communication unit 112, and to receive data through the second communication unit 114.

The data request unit 104 makes a request for data corresponding to a user's request. When the portable terminal 100 performs handover to a heterogeneous system, the data request unit 104 requests to receive data through the heterogeneous system.

Operations of the controller 102 and the data request unit 104 can be executed by a specific software module (i.e., a set of instructions) having been stored in the memory unit 106.

The memory unit 106 is composed of at least one of a Read Only Memory (ROM), a Random Access Memory (RAM), and a flash ROM. The ROM stores a microcode of a program for processing and controlling the controller 102 and the data request unit 104, and stores a variety of reference data.

The RAM, which is a working memory of the controller 102, stores temporary data generated in the execution of a variety of programs. The flash ROM stores a diversity of updateable depository data such as a phone book, an outgoing message, and an incoming message, and receives and stores data requested by a user according to the exemplary embodiment of the present invention.

The memory unit 106 stores the software module to perform operations of the controller 102 and the data request unit 104 according to the present invention.

The input unit 108 includes numeral key buttons ‘0’ to ‘9’, a menu button, a cancel button, an OK button, a talk button, an end button, an Internet button, navigation key (or direction key) buttons, and a plurality of function keys such as a character input key. The input unit 108 provides key input data, corresponding to a key pressed by a user, to the controller 102. For example, the input unit 108 provides the controller 102 with key input data for connecting to a WiFi network 115 in the course of data request and data reception through the mobile communication network 113.

The display unit 110 displays status information generated during operation of the portable terminal 100, displays characters, and is capable of displaying a large amount of moving pictures, still pictures and the like. The display unit 110 can be a color Liquid Crystal Display (LCD), an Active-Matrix Organic Light-Emitting Diode (AMOLED) or the like. The display unit 110 includes a touch input device and, when being applied to the portable terminal 100 for use in a touch input scheme, the display unit 110 can be used as an input device of the portable terminal 100.

The first communication unit 112 and the second communication unit 114 perform a function of transmitting/receiving and processing a wireless signal of data that are input/output through an antenna (not shown). For example, the first communication unit 112 is a module for communicating with the mobile communication network 113. At transmission, the first communication unit 112 performs a function of processing original data through channel coding and spreading, converting the original data into a Radio Frequency (RF) signal, and transmitting the RF signal. At reception, the first communication unit 112 performs a function of converting a received RF signal into a baseband signal, processing the baseband signal through de-spreading and channel decoding, and restoring the signal to original data. Further, the second communication unit 114 refers to a module for communicating and connecting with the WiFi network 115.

The relay server 120 is a server for relaying a connection of the mobile communication network 113 and the WiFi network 115. The relay server 120 can include a server controller 122, a connection check unit 124, a memory unit 126, a buffer 128, and a communication unit 130.

The server controller 122 of the relay server 120 transmits a data request, generated from the portable terminal 100, to the data server 140, and transmits data, provided from the data server 140, to the portable terminal 100. Further, if the server controller 140 finds that the portable terminal 100 connects to the WiFi network 115 in the course of receiving data through the mobile communication network 113, the server controller 140 processes to transmit data, provided from the data server 140, to the portable terminal 100 using the WiFi network 115.

At this time, the server controller 122 processes to store data, which are received from the data server 140 from a time point of notifying that the portable terminal 100 intends to connect to the WiFi network 115 to a time point of actually connecting to the WiFi network 115, in the buffer 128. Then, after the portable terminal 100 connects to the WiFi network 115, the server controller 122 processes to transmit the buffered data to the portable terminal 100 through the WiFi network 115.

Under the control of the server controller 122, the connection check unit 124 checks a change of a communication connection of the portable terminal 100 from the mobile communication network 113 to the WiFi network 115.

Operations of the server controller 122 and the connection check unit 124 can be executed by a specific software module (i.e., a set of instructions) having been stored in the memory unit 126.

The memory unit 126 of the relay server 120 stores data for an operation of the relay server 120 and also stores a plurality of data (e.g., contents) to be provided to a user of the portable terminal 100.

The buffer 128 of the relay server 120 temporarily stores data, which are received from the data server 140 between a time point of notifying that the portable terminal 100 intends to connect to the WiFi network 115 and a time point of actually connecting to the WiFi network 115.

The communication unit 130 is a module for communicating with the portable terminal 100. The communication unit 130 can connect with the portable terminal 100 through the mobile communication network 113, as shown in FIG. 1. Further, the communication unit 130 can include a module capable of connecting with the WiFi network 115, and connect with the portable terminal 100 through the WiFi network 115, as shown in FIG. 1. In addition, the communication unit 130 transmits a data request of the portable terminal 100 to the data server 140, receives requested data from the data server 140, and transmits the received data to the portable terminal 100.

Therefore, the communication unit 130 provides data, received from the data server 140, to the portable terminal 100 through the mobile communication network 113 and, at a time point at which the portable terminal 100 connects to the WiFi network 115, provides data received from the data server 140, to the portable terminal 100 through the WiFi network 115.

In FIG. 1, the relay server 120 and the data server 140 are separate and independent, and constructed in the exemplary embodiment of the present invention. In an alternative embodiment, the data server 140 may be also constructed to be incorporated in the relay server 120 to perform a role of the relay server 120. Alternatively, the relay server may be constructed to be incorporated in the data server 140.

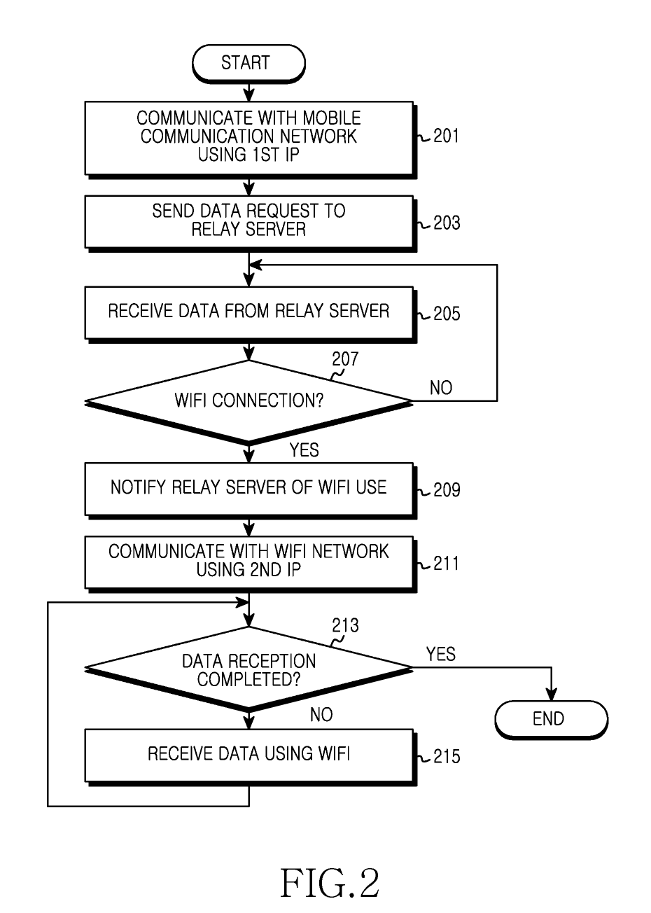

FIG. 2 is a flowchart illustrating a process of receiving data in the portable terminal 100 according to the exemplary embodiment of the present invention.

Referring to FIGS. 1-2, the portable terminal 100, which is a portable terminal supporting the mobile communication network 113 and a heterogeneous network (i.e., the WiFi network 115), can change a communication mode according to a signal received from each system and maintain communications through the changed communication mode.

In step 201, the portable terminal 100 for receiving data establishes a communication connection with the mobile communication network 113 using a first Internet Protocol (IP) that is used for connecting with the mobile communication network 113. After that, the portable terminal 100 proceeds to step 203 and sends a request for data, intended to be received, to a relay server 120.

Here, the relay server 120, which is a server for relaying a connection of the mobile communication network 113 and the WiFi network 115, forwards a received data request of the portable terminal 100 to the data server 140, that is a server providing data.

After that, the portable terminal 100 proceeds to step 205 and receives data from the relay server 120 and stores the received data. Next, the portable terminal 100 proceeds to step 207 and checks whether to establish a WiFi connection. Here, step 207 can be the step of checking whether the portable terminal 100 senses a user's request of instructing WiFi use or searches an AP stored in a WiFi profile.

Further, the relay server 120 is to transmit data, provided from the data server 140, to the portable terminal 100. According to the present invention, when the relay server 120 finds that the portable terminal 100 connects to the WiFi network 115 in the course of receiving data through the mobile communication network 113, the relay server 120 processes to transmit data, provided from the data server 140, to the portable terminal 100 through the WiFi network 115.

If the step 207 of checking determines that the portable terminal 100 does not establish the WiFi connection, the portable terminal 100 again performs the process of step 205 so as to receive data provided from the data server 140.

However, if the step 207 of checking determines that the portable terminal 100 establishes the WiFi connection, the portable terminal 100 proceeds to step 209 and notifies the relay server 120 of the use of the WiFi network 115. Next, in step 211, the portable terminal 100 performs communications with the WiFi network 115 using a second IP that is used for connecting with the WiFi network 115.

After that, the portable terminal 100 proceeds to step 213 and checks if the portable terminal 100 has completed the data reception. Here, step 213 is to check if the portable terminal 100 completes the data reception through the mobile communication network 113 before connecting to the WiFi network 115.

If the step 213 of checking determines that the data reception is completed, the portable terminal 100 terminates the method according to the present invention in FIG. 2 in a state of connection with the WiFi network 115.

However, if the step 213 of checking determines that the data reception is not completed, the portable terminal 100 proceeds to step 215 and receives data using the WiFi network 115, and loops back to continue checking in step 213 if data reception is complete.

In the prior art, a data server fails to recognize that a portable terminal is connected to a WiFi network in the course of receiving data through a mobile communication network, so the prior art data server keeps transmitting data to the portable terminal through the mobile communication network despite the fact that the portable terminal is in a state of connection to the WiFi network. On the contrary, the present invention includes a relay server 120 capable of confirming that the portable terminal 100 intends to connect with the WiFi network 115 in step 209. Due to such confirmation in the present invention, the relay server 120 can transmit data, provided from the data server 140, to the portable terminal 100 through the WiFi network 115.

After receiving the data through the WiFi network 115, the portable terminal 100 returns to step 213 and again checks if data reception is completed, receives data through the WiFi network 115 until the data reception is completed, and terminates the method according to the present invention in FIG. 2 when the data reception is completed.

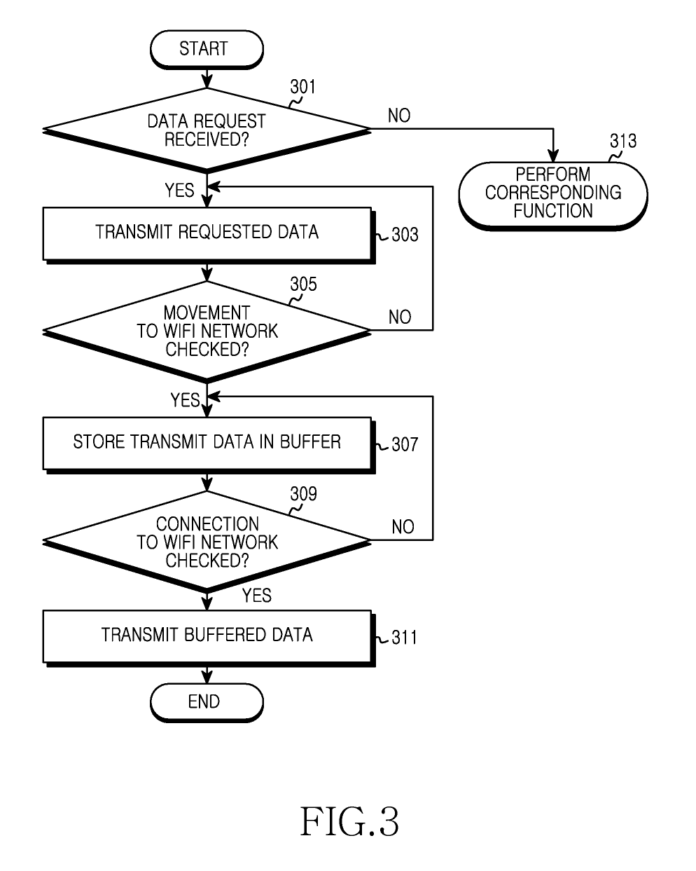

FIG. 3 is a flowchart illustrating a process of providing data in the relay server 120 according to the exemplary embodiment of the present invention.

Referring to FIGS. 1 and 3, when the relay server 120, which is a server relaying connection of the mobile communication network 113 and the WiFi network 115, finds that the portable terminal 100 connects to the WiFi network 115 in the course of receiving data through the mobile communication network 113, the relay server 120 processes to transmit data, provided from the data server 140, to the portable terminal 100 using the WiFi network 115.

In step 301, the relay server 120 for providing data checks if the relay server 120 receives or has received a data request from the portable terminal 100.

If the checking in step 301 determines that the relay server 120 does not receive any data request, the relay server 120 proceeds to step 313 and performs a corresponding function (e.g., a sleep mode).

However, if the checking in step 301 determines that the relay server 120 receives the data request, the relay server 120 proceeds to step 303 and transmits data, corresponding to the data request, to the portable terminal 100.

A process of transmitting data to the portable terminal 100 is described below.

First, the relay server 120 transmits a data request of the portable terminal 100 to the data server 140 and, in response to the received data request, the data server 140 searches and provides requested data to the relay server 120. At this time, the relay server 120 establishes a communication connection with the portable terminal 100 through a first IP and then transmits the requested data, provided from the data server 140, to the portable terminal 120.

After transmitting the requested data to the portable terminal 100, the relay server 120 proceeds to step 305 and checks if the portable terminal 100 moves to or otherwise establishes a communication connection with the WiFi network 115. At this time, when the relay server 120 receives information notifying of the use of the WiFi network 115 by the portable terminal 100, the relay server 120 can confirm that the portable terminal 100 has moved to the WiFi network 115. Further, the relay server 120 can receive information about a second IP capable of providing data through the WiFi network 115, from the portable terminal 100.

If the checking in step 305 determines that the portable terminal 100 moves to or establishes a communication connection with the WiFi network 115, the relay server 120 proceeds to step 307; otherwise, the method loops back to step 303. In step 307, the method stores data provided from the data server 140, i.e., transmit data, in a buffer. Then, the relay server 120 proceeds to step 309 and checks if the portable terminal 100 completes connection with the WiFi network 115.

If the checking in step 309 determines that the portable terminal 100 does not complete the connection with the WiFi network 115, the relay server 120 returns to step 307 and keeps storing data, provided from the data server 140, in the buffer. That is, until before the portable terminal 100 connects with the WiFi network 115, the relay server 120 stores data provided from the data server 140 in the buffer.

In contrast, if the checking in step 309 determines that the portable terminal 100 completes the connection with the WiFi network 115, the relay server 120 proceeds to step 311 and transmits the buffered data to the portable terminal 100.

At this time, the relay server 120 discontinues transmitting data through the previously connected mobile communication network 113, and transmits data through the newly connected WiFi network 115.

Due to the disclosed method of the present invention, the portable terminal 100 can increase a transmission speed by means of the WiFi network 115, reducing a cost for data use.

Further, when the relay server 120 confirms that the portable terminal 100 does not connect with the WiFi network 115 during a constant time after receiving the information notifying the use of the WiFi network 115 from the portable terminal 100, the relay server 120 processes to transmit the buffered data to the portable terminal 100 using the previously connected mobile communication network 113.

After that, the relay server 120 terminates the method according to the present invention shown in FIG. 3.

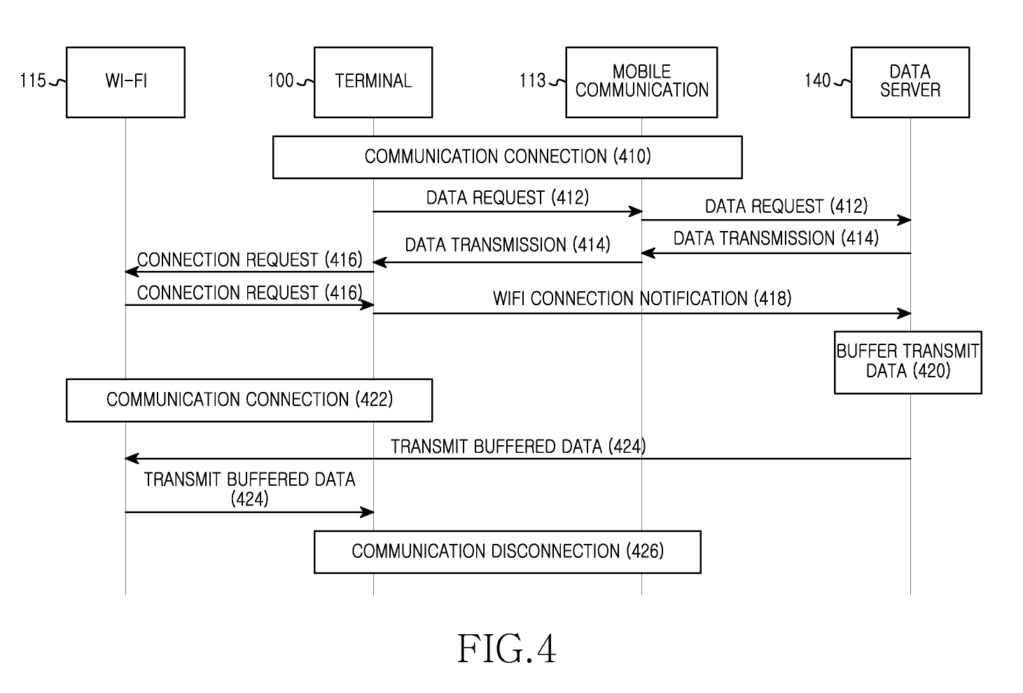

FIG. 4 is a ladder diagram illustrating a data transmission process of the mobile communication system according to the exemplary embodiment of the present invention.

Referring to FIG. 4, the mobile communication system can include a portable terminal 100, a mobile communication network 113, a WiFi network 115, and a data server 140.

Here, the data server 140 plays a role of a relay server relaying connection of the mobile communication network 113 and the WiFi network 115. When the data server 140 finds that the portable terminal 100 connects to the WiFi network 115 in the course of receiving data through the mobile communication network 113, the data server 140 processes to transmit, in place of the relay server 120 in FIG. 1, data intended to be transmitted to the portable terminal 100 through the WiFi network 115.

First, the portable terminal 100 establishes a communication connection with the mobile communication network 113 in step 410, and then the portable terminal 100 sends a data request to the data server 115 in step 412. At this time, the data request is transmitted to the data server 140 through the mobile communication network 113.

In response to the data request, the data server 140 searches requested data, and transmits the requested data to the portable terminal 100 through the mobile communication network 113 in step 414. At this time, the portable terminal 100 communicates with the mobile communication network 113 using a first IP, and the data server 140 transmits data to the portable terminal 100 using the first IP.

When the portable terminal 100 intends to connect with the WiFi network 115, the portable terminal 100 sends a connection request to the WiFi network 115 (i.e., an AP) in step 416, and then attempts a connection with the WiFi network 115. At this time, the portable terminal 100, being connected with the mobile communication network 113, then connects with the WiFi network 115, indicates that the portable terminal intends to perform a handover to a heterogeneous network.

At this time, the WiFi network 115 transmits information, notifying that the portable terminal 100 intends to connect with the WiFi network 115, to the data server 140 in step 418. Further, the WiFi network 115 communicates with the portable terminal 100 using a second IP, and transmits the second IP, for communicating with the portable terminal 100, to the data server 140.

In the prior art, a data server fails to recognize the fact that a portable terminal performs a handover to a heterogeneous network, so the data server in the prior art continues to transmit data through a previously connected communication path. Therefore, undesirably, the data server in the prior art continues to transmit data through a mobile communication network despite the fact that the portable terminal establishes a connection to a WiFi network.

To solve the above problem, in the present invention, when receiving information notifying that the portable terminal 100 intends to connect with the WiFi network 115, the data server 140 discontinues transmitting data through the first IP and stores data, intended to be transmitted, in a buffer in step 420.

After that, at a time point at which the portable terminal 100 completes a communication connection to the WiFi network 115 in step 422, the data server 140 transmits the buffered data to the portable terminal 100 through the second IP in step 424, and releases the connection of the first IP in step 426. That is, the buffered data is transmitted to the portable terminal 100 through the WiFi network 115.

When the portable terminal 100 does not connect with the WiFi network 115 after a predetermined time, the data server 140 transmits the buffered data to the portable terminal 100 through the first IP.

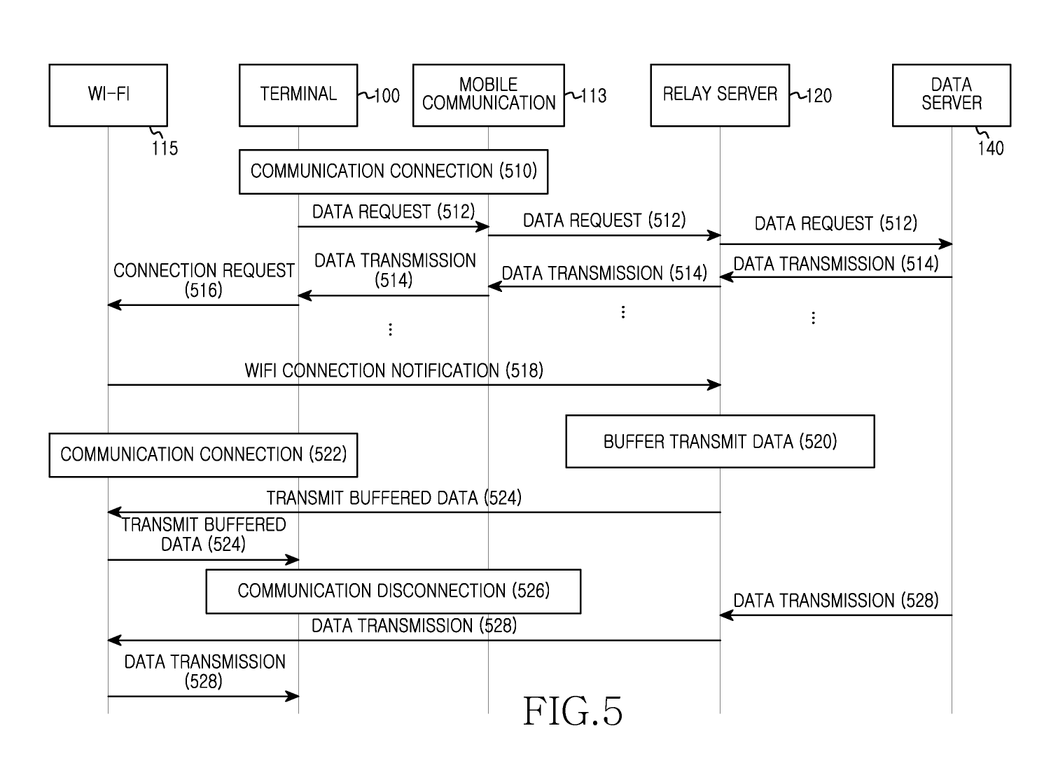

FIG. 5 is a ladder diagram illustrating a data transmission process of a mobile communication system according to an alternative exemplary embodiment of the present invention.

Referring to FIGS. 1 and 5, the mobile communication system can include a portable terminal 100, a mobile communication network 113, a WiFi network 115, a data server 140, and a relay server 120 relaying a connection of the mobile communication network 113 and the WiFi network 115.

The relay server 120, which is a server relaying the connection of the mobile communication network 113 and the WiFi network 115, transmits data, provided by the data server 140, to the portable terminal 100. Further, when the relay server 120 finds that the portable terminal 100 connects to the WiFi network 115 in the course of receiving data through the mobile communication network 113, the relay server 120 processes to transmit data, provided from the data server 140, to the portable terminal 100 using the WiFi network 113.

The portable terminal 100 establishes a communication connection with the mobile communication network 113 in step 510, and then the portable terminal 100 sends a data request to the data server 140 in step 512. At this time, the data request is transmitted to the relay server 120 through the mobile communication network 113, and is transmitted by the relay server 120 to the data server 140.

In response to the received data request, the data server 140 searches and provides requested data to the relay server 120, and then the relay server 120 transmits the data, provided from the data server 140, to the portable terminal 100 through the mobile communication network 113 in step 514.

When the portable terminal 100 intends to connect with the WiFi network 115, the portable terminal 100 sends a connection request to the WiFi network 115 (i.e., an AP) in step 516, and then attempts a connection with the WiFi network 115. At this time, the portable terminal 100, being connected with the mobile communication network 113, connects with the WiFi network 115 which indicates that the portable terminal intends to perform a handover to a heterogeneous network.

In response to the connection request received from the portable terminal 100, the WiFi network 115 transmits information, notifying that the portable terminal 100 intends to connect with the WiFi network 115, to the relay server 120 in step 518. At this time, the WiFi network 115 communicates with the portable terminal 100 using a second IP, and transmits the second IP, for communicating with the portable terminal 100, to the relay server 120.

In the prior art, a data server fails to recognize the fact that a portable terminal performs a handover to a heterogeneous network, so the data server in the prior art continues to transmit data through a previously connected communication path. Therefore, undesirably, the data server in the prior art continues to transmit data through a mobile communication network despite the fact that the portable terminal establishes connection to a WiFi network.

To solve the above problem, in the present invention, when receiving information notifying that the portable terminal 100 intends to connect with the WiFi network 115, the relay server 120 discontinues transmitting data through the first IP and stores data, provided from the data server 140, in a buffer in step 520. At this time, the relay server 120 keeps transmitting the data, provided from the data server 140, to the portable terminal 100 through the first IP, until before receiving the information notifying that the portable terminal 100 intends to connect with the WiFi network 115.

After that, at a time point at which the portable terminal 100 completes a communication connection to the WiFi network 115 in step 522, the relay server 120 transmits the buffered data to the portable terminal 100 through the second IP in step 524, and releases the connection of the first IP in step 526. That is, the buffered data is transmitted to the portable terminal 100 through the WiFi network 115. Further, the relay server 120 transmits data, provided from the data server 140 as well as the buffered data, to the portable terminal 100 through the WiFi network 115 in step 528.

When the portable terminal 100 does not connect with the WiFi network 115 after a predetermined time, the relay server 120 transmits the buffered data to the portable terminal 100 through the first IP.

As described above, exemplary embodiments of the present invention are disclosed and provided to improve data reception performance of a portable terminal using a relay server. When the portable terminal performs a handover to a heterogeneous network, the relay server transmits data to the portable terminal through the heterogeneous network. This enables the portable terminal to receive data through the handover heterogeneous network.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for transmitting data in a relay server, the apparatus comprising:
a server controller for receiving data, requested by a portable terminal, from a data server;
a connection check unit for checking a heterogeneous network handover of the portable terminal; and
a communication unit for communicating with the portable terminal and the data server,
wherein the server controller processes to transmit data, received from the data server, to the portable terminal through a first communication connection and, when the server controller checks that the portable terminal intends to perform the heterogeneous network handover, to transmit buffer data received from the data server, and then, at a time point at which the portable terminal completes the heterogeneous network handover execution, to transmit the buffered data to the portable terminal through a second communication connection.

2. The apparatus of claim 1, wherein the relay server is comprised in the data server.

3. The apparatus of claim 1, wherein the first communication connection is a communication connection with a mobile communication network, and the second communication connection is a communication connection with a Wireless Fidelity (WiFi) network.

4. The apparatus of claim 1, wherein, after buffering the data received from the data server, when the portable terminal does not complete the heterogeneous network handover execution after a predetermined time, the server controller processes to transmit the buffered data to the portable terminal through the first communication connection.

5. A method for transmitting data in a relay server, the method comprising:
receiving data, requested by a portable terminal, from a data server;
transmitting the data, received from the data server, to the portable terminal through a first communication connection;
responsive to checking that the portable terminal intends to perform a heterogeneous network handover, buffering data received from the data server; and
when the portable terminal completes the heterogeneous network handover execution, transmitting the buffered data to the portable terminal through a second communication connection,
wherein the heterogeneous network handover establishes a communication connection to the second communication network in a state of connection with the first communication network.

6. The method of claim 5, wherein the relay server is comprised in the data server.

7. The method of claim 5, wherein the first communication connection is a communication connection with a mobile communication network, and the second connection is a communication connection with a Wireless Fidelity (WiFi) network.

8. The method of claim 5, further comprising, after buffering the data received from the data server, when the portable terminal does not complete the heterogeneous network handover execution after a predetermined time, transmitting the buffered data to the portable terminal through the first communication connection.

9. A mobile communication system for data transmission, the system comprising:
a portable terminal for sending a data request to a data server via a relay server, and receiving requested data from the data server;
the relay server for transmitting a data request of the portable terminal to the data server, and transmitting data, received from the data server, to the portable terminal; and
the data server for storing a plurality of data, searching data corresponding to a data request of the portable terminal, and providing the searched data to the relay server,
wherein the relay server transmits data, provided from the data server, to the portable terminal through a first communication connection and, when the portable terminal performs a heterogeneous network handover, transmits data, provided from the data server, to the portable terminal through a second communication connection.

10. The system of claim 9, wherein, from a time point at which the portable terminal intends to perform the heterogeneous network handover, the relay server buffers data received from the data server and, at a time point at which the portable terminal completes the heterogeneous network handover, the relay server transmits the buffered data to the portable terminal

11. The system of claim 9, wherein, when the portable terminal intends to perform the heterogeneous network handover, the portable terminal notifies the relay server of the heterogeneous network handover execution by providing the relay server with Internet Protocol (IP) information that is used for connecting with a heterogeneous network.

12. A method for receiving a data in a portable terminal, the method comprising:
sending a data request to a relay server;
receiving requested data using a first communication connection from the relay server;
receiving requested data using a second communication connection from the relay server when the portable terminal performs a heterogeneous network handover.
